(19) United States
(12) Patent Application Publication
(10) Pub. No.: US 2012/0285816 A1
(43) Pub. Date: Nov. 15, 2012

(54) METHOD FOR ISOLATING AN ALKANOL FROM AN AQUEOUS BIOTRANSFORMATION MIXTURE

(75) Inventors: Jürgen Däuwel, Heidelberg (DE); Michael Breuer, Darmstadt (DE); Bernhard Hauer, Fussgonheim (DE)

(73) Assignee: BASF SE, Ludwigshafen (DE)

(21) Appl. No.: 13/511,594

(22) PCT Filed: Nov. 24, 2010
(86) PCT No.: PCT/EP2010/068139

§ 371 Date: May 23, 2012

(30) Foreign Application Priority Data
Nov. 24, 2009 (EP) 09176942.2

(51) Int. Cl. B01D 3/36

(52) U.S. Cl. 203/46

(57) ABSTRACT

The invention relates to the isolation of an alkanol from an aqueous biotransformation mixture, in that a) a first alkanol phase is obtained by means of distilling out an alkanol-water azeotrope from the aqueous biotransformation mixture and, if the azeotrope is a heteroazeotrope, phase separating the azeotrope and separating out an aqueous phase, b) a second alkanol phase is obtained by (i) liquid/liquid extracting the first alkanol phase using a solvent as an extracting agent, or (ii) azeotropic drying the first alkanol phase in the presence of the solvent as a carrier agent, and c) the second alkanol phase is fractionally distilled, producing a pure alkanol fraction. The biotransformation mixture is obtained, for example, by means of reducing an alkanol in the presence of an alcohol dehydrogenase. The method is adapted to the severe dilution of the products of value in the biotransformation mixture and works without long phase separation times when extracting by means of organic solvents.

The invention relates to a method for isolating an alkanol from an aqueous biotransformation mixture.

The biotechnological-chemical synthesis of organic-chemical compounds with the help of isolated enzymes or enzymes present in cells is known as so-called “biotransformation”. During biotransformation, the enzymatic conversion of a substrate, i.e. of a non-natural (xenobiotic) compound, into a product of value takes place.

Biotransformation is characterized by high chemo-, region- and stereospecificity even in the case of complex substrates and mixtures. In conjunction with high space-time yields, relatively low-cost, renewable starting materials, and an often better environmental compatibility of the processes, these advantages have led to the number of biotransformation processes used in industry increasing enormously.

The focus for the application of this technology lies in the preparation of optically active products.

WO 2006/53713 describes a process for the preparation of (S)-butan-2-ol by reducing butan-2-one in the presence of an alcohol dehydrogenase (ADH) with a certain polypeptide sequence. Preferably, the enantioselective reduction with the ADH takes place in the presence of a reducing agent, such as glucose or formate, which regenerates the cofactor oxidized in the course of the reduction. To regenerate the coenzyme, a second dehydrogenase, such as e.g. glucose dehydrogenase or formate dehydrogenase, can be added.

WO 2005/108590 discloses a process for the preparation of optically active alkanols where, in an alkanone-comprising medium, an enzyme (E), selected from the classes of the dehydrogenases, aldehyde reductases and carbonyl reductases, is incubated in the presence of reduction equivalents, during which the reduction equivalents consumed in the course of the reaction are regenerated again by reacting a sacrificial alcohol to the corresponding sacrificial ketone with the help of the enzyme (E).

Various processes for working-up biotransformation products from the culture broth of microorganisms are known from the literature. The work-up processes here have to be adapted to certain specifics of the biotransformation, such as, in particular, the considerable dilution of the products of value in the culture broth and/or contamination with cell constituents.

Volatile or steam-volatile compounds can be driven off from the culture broth during the reaction using a stripping gas. One such process is described e.g. in US 2005/089979.

However, the process is only suitable in cases where the starting substrates do not have noteworthy volatility.

In many cases, following the biotransformation, the crude-product-containing culture broths are evaporated to dryness and the biotransformation products are then extracted using an organic solvent. In the case of a whole-cell biotransformation, if appropriate a cell separation step, for example by means of centrifugation, filtration, etc., is carried out prior to the concentration.

In these processes, the biotransformation product is contaminated to a considerable extent by lipophilic cell constituents, which makes complex purification operations necessary. According to the prior art, in most cases a thermal purification process (distillation) is used in order to separate the desired product from the lipophilic cell constituents. For steam-volatile compounds, high loss rates are sometimes observed with this process.

Alternatively, the biotransformation products are extracted with organic solvents, e.g. ethers, from the aqueous culture medium. For this, a one- to ten-fold excess of organic solvent usually has to be added to the aqueous phase.

One problem during the extraction is that when adding the organic solvent to the culture medium, gel- and slime-formation phenomena arise. These hinder, sometimes considerably, the isolation of the biocatalytically prepared compounds and drastically impair the yield.

The gel formation and slime formation during extraction with organic solvents is attributed to the presence of emulsifying agents in the cell suspension or in the cell-free culture medium. The presence of emulsifying agents during the extraction lowers the efficiency of the extraction with regard to quantity and purity of the product to be isolated. At the same time, the presence of emulsifying agents leads to the formation of gels or slimes that are stable for several weeks or months.

So-called bioemulsifiers have been identified as a constituent of these emulsifying agents. Although it is known to destroy these bioemulsifiers by adding hydrolases, the hydrolases used for the enzymatic demulsification contribute considerably to the complexity and the costs of the process.

It is therefore an object of the invention to provide a process for isolating alkanols, in particular optically active alkanols, from an aqueous biotransformation broth, which process is adapted to the considerable dilution of the products of value in the biotransformation broth and is possible without long phase separation times during the extraction with organic solvents.

The object is achieved by a process for isolating an alkanol from an aqueous biotransformation broth, in which

a) a first alkanol phase is obtained by distilling off an alkanol/water azeotrope from the aqueous biotransformation broth and, if the azeotrope is a heteroazeotrope, phase separation of the azeotrope and separating off of an aqueous phase,

b) a second alkanol phase is obtained by
(i) liquid/liquid extraction of the first alkanol phase with a solvent as extractant; or
(ii) azeotropic drying of the first alkanol phase in the presence of the solvent as entrainer, and

c) the second alkanol phase is fractionally distilled to give a pure alkanol fraction.

The first alkanol phase has a first water content, the second alkanol phase a second water content. The second water content is lower than the first water content. Water content is understood here as meaning the amount of water based on the alkanol fraction.

The fractional distillation in step c) can be carried out discontinuously (batch procedure) or continuously.

In the present case, biotransformation is understood as meaning the conversion of a substrate which is catalyzed by isolated enzymes or enzyme systems, immobilized enzymes or enzyme systems, enzyme raw extracts, whole cells, resting cells and/or disrupted cells. Fermentations are also included here.

The work-up process according to the invention takes place when the biotransformation is complete, i.e. as soon as a desired conversion (of e.g. 90% or more) has been reached.

The process according to the invention has the advantage that the biotransformation broth does not have to be subjected to complex mechanical separating or purification operations, such as, for example, a separating off of biomass, for example by centrifugation or filtration. Already in the first step of the process, a significant concentration of the product of value takes place, with a reduction in the volumes which have to be handled in the subsequent steps. Thus, for example, the azeotrope of 2-butanol and water has a 2-butanol content of about 72% by weight. The boiling point of the azeotrope, being about 87° C. at atmospheric pressure, is significantly below the boiling points of water and 2-butanol, which are in each case about 100° C.

The process can in principle be applied to the isolation of any desired alkanol prepared by biotransformation which forms an azeotrope with water. The azeotrope may be a homogeneous azeotrope or heteroazeotrope. The alkanols include C₂-C₈-alknanols, in particular C₄-C₈-alkanols, the alkyl chain of which may be straight-chain or branched and which may be primary, secondary or tertiary alcohols. Preferably, the alkanol is selected from optically active alkanols, in particular optically active 2-alkanols. Particularly preferred examples are S-2-butanol, S-2-pentanol and S-2-hexanol.

In a first step, an alkanol/water azeotrope is distilled off from the aqueous biotransformation broth. Implementation of the distillation in apparatus terms is possible in various configurations.

The heating of the biotransformation broth to boiling can take place in any desired heatable vessel, e.g. a stirred-tank reactor with heating jacket, or evaporator. In terms of apparatus, for this purpose, stirred tanks, falling-film, thin layer, forced-decompression circulation, and other evaporator designs can be used in natural or forced-circulation mode. However, the use of evaporators is less preferred since certain constituents in the biotransformation broth can lead to the rapid fouling of the evaporator. In one expedient embodiment, the biotransformation broth, when the biotransformation is complete, is heated directly in the reaction vessel. The heating rate up to the boiling temperature is preferably at least 20 K/min. In the case of slower heating, there is the risk of undesired secondary reactions, in particular of racemization in the case of optically active alcohols.

The distillation can be configured as a simple distillation, i.e. essentially without mass transfer between rising vapors and refluxing condensate, or as rectification. For the latter, all known designs of distillation or rectification columns, as explained e.g. below, are suitable.

Distilling off the alkanol/water azeotrope takes place under suitable conditions of pressure and temperature. If desired, the distillation can be carried out under reduced pressure. In general, working under ambient pressure is preferred on account of the lower expenditure in terms of apparatus.

The vapor comprising the alkanol/water azeotrope is at least partly condensed. Of suitability for this purpose are any desired heat exchangers or condensers, which may be air-cooled or water-cooled.

If the alkanol forms a homogeneous azeotrope with water, the first alkanol phase obtained as condensate can be returned to the further work-up. Some of the condensate can be added to the rectification column as reflux.

If the alkanol forms a heteroazeotrope with water, the condensate decomposes into an aqueous phase and an organic phase, which can be separated from one another in a suitable phase-separation vessel or decanter. The aqueous phase can be fed back to the evaporation vessel, e.g. as reflux to the rectification column. During the phase separation, the first alkanol phase is obtained as organic phase.

On account of the solubility of water, the first alkanol phase comprises dissolved water. Prior to a further distillative purification, the first alkanol phase must therefore be dried. In one embodiment, the drying of the first alkanol phase takes place by liquid/liquid extraction using a solvent as extractant. Suitable extractants are solvents in which water has only very slight solubility or is essentially insoluble. On account of the presence of an extractant, which lowers the solubility of water in the alkanol to be purified, the water is separated out and forms its own phase, which can be separated off.

For the liquid/liquid extraction, the procedure expediently involves bringing the first alkanol phase into close contact with the solvent and separating off an aqueous phase by decantation, giving the second alkanol phase.

Of suitability for intense thorough mixing are suitable apparatuses, such as e.g. a stirred tank, centrifugal extractor, countercurrent extractor and the like.

The solvent phase and the aqueous phase are then separated from one another. The second alkanol phase produced as solvent phase then comprises the alkanol dissolved in the solvent with a considerably reduced fraction of water.

Alternatively, the first alkanol phase can be subjected to azeotropic drying in the presence of a solvent as entrainer. During the azeotropic drying, the dissolved water is removed as water/solvent azeotrope.

For the azeotropic drying, the procedure expediently involves heating the first alkanol phase in a distillation vessel in the presence of the solvent and removing water as water/solvent azeotrope, leaving behind the second alkanol phase in the distillation vessel. The vapors comprising water/solvent azeotrope are distilled off and at least partly condensed, the condensate is separated into an aqueous phase and a solvent phase and the solvent phase is returned to the distillation vessel.

The solvent suitable as extractant or entrainer is selected, for example, from aliphatic hydrocarbons, such as pentane, hexane, heptane, cyclohexane, methylcyclohexane; aromatic hydrocarbons, such as benzene, toluene, xylenes; halogenated hydrocarbons, such as dichloromethane, trichloromethane, dichloroethane, chlorobenzene. Aliphatic hydrocarbons, such as in particular n-hexane, are particularly preferred on account of their comparative non-toxicity and ability to be easily separated off from the alkanol.

The second alkanol phase is then fractionally distilled to give a pure alkanol fraction. During the fractional distillation, the alkanol is freed from the added solvent, unreacted substrate, residual water, by-products and the like.

Implementation of the distillation in terms of apparatus is possible in various configurations. All known designs of distillation or rectification columns are suitable. The “rectification column” comprises separation-efficient internals such as trays, random packings and/or structured packings. In order to improve the separation efficiency in the column, a part-stream of the condensate is usually fed back to the column again.

In typical tray columns, sieve trays, bubble-cap trays or valve trays are installed, through which the liquid flows. The vapor is passed through special slots or holes, so as to form a froth layer. A new evaporation equilibrium is established on each of these trays.

Columns with random packings may be filled with random packings of different shapes.

The increase in surface area associated therewith optimizes heat and mass transfer and thus increases the separating capacity of the column. Typical examples of such random packings are the Raschig ring, Pall ring, Hiflow ring, Intalox saddle, Berl saddle and hedgehogs. The random packings may be introduced into the column in an ordered manner, or else in a random manner (as a bed). Suitable materials are glass, ceramic, metal and plastics.

Structured packings are a further development of the ordered random packings. They have a regularly shaped structure. There are various embodiments of structured packings, e.g. fabric or sheet-metal packings. Materials which can be used are metal, plastic, glass and ceramic. Compared to tray columns, columns with structured packings have a very small amount of liquid therein. This is often advantageous for the rectification since this reduces the risk of thermal decomposition of the substances.

In one embodiment, the second alkanol phase is introduced into a fractionating column at the side, the pure alkanol fraction is drawn off as side-stream, a fraction boiling lower than the alkanol fraction is drawn off overhead and a fraction boiling higher than the alkanol fraction is drawn off in the bottom.

In another embodiment, the second alkanol phase is discontinuously distilled, giving, in succession, a fraction boiling lower than the alkanol fraction, the pure alkanol fraction and a fraction boiling higher than the alkanol fraction.

The fraction boiling lower than the alkanol fraction comprises the majority of the solvent used and can advantageously be returned at least partly as solvent to step b).

The aqueous biotransformation broth which is used in the process according to the invention is obtained by any desired biotransformation process which converts a substrate into an alkanol. These include both the fermentative preparation of alkanols and also the enzymatic preparation of alkanols. In the fermentative preparation, alkanols are produced during the metabolization of fermentable carbon sources by an alkanol-producing microorganism. Enzymatic preparation (or biotransformation in the narrower sense) is understood as meaning the selective chemical conversion of defined-purity substances (starting materials) into products by enzymes, where the enzymes may be present in living, resting or disrupted cells or may be enriched or isolated.

a) Fermentative preparation of alkanols

The fermentative preparation of alkanols is known per se from the prior art. Thus, for example, WO 2008/137403 describes a process for the preparation of 2-butanol by fermentation.

Examples of suitable natural or recombinant, pro- or eukaryotic microorganisms for the fermentative preparation are those which are suitable, under aerobic or anaerobic conditions, for the fermentative production of the desired alkanol. In particular, mention should be made of bacteria which are selected from bacteria of the families Enterobacteriaceae, Pseudomonadaceae, Bacillaceae, Rhizobiaceae, Clostridiaceae, Lactobacillaceae, Streptomycetaceae, Rhodococcaceae, Rhodocyclaceae and Nocardiaceae. Examples of suitable genera comprise in particular Escherichia, Streptomyces, Clostridium, Corynebacterium and Bacillus.

Suitable fermentation conditions, media, fermenters and the like can be established by the person skilled in the art within the framework of his general specialist knowledge. For this purpose, he may use e.g. details in suitable specialist literature, such as Rehm et al, Biotechnology, Vol. 3 Bioprocessing, 2nd Ed., (Verlag Chemie, Weinheim). Thus, the microorganisms can be cultivated continuously, with and without recycle of the biomass, or discontinuously in the batch process (batch cultivation) or in the fed batch (feed process) or repeated fed batch process (repeated feed process). The fermentation can be carried out in stirred fermenters, bubble columns and loop reactors. A summary of known cultivation methods can be found in the textbook by Chmiel (Bioprozeβtechnik 1. Einführung in die Bioverfahrenstechnik [Bioprocess technology 1. Introduction to bioprocess technology] (Gustav Fischer Verlag, Stuttgart, 1991)) or in the textbook by Storhas (Bioreaktoren and periphere Einrichtungen [Bioreactors and peripheral equipment] (Vieweg Verlag, Braunschweig/Wiesbaden, 1994)).

For this purpose, a sterile culture medium is prepared which comprises the substrate or the substrates and also further additives optionally required for the growth of the microorganism and product formation, such as carbon and/or nitrogen sources, trace elements and the like, and is inoculated with a suitable amount of fresh preculture of the microorganism.

The culture medium to be used must suitably meet the requirements of the particular strains. Descriptions of culture media for various microorganisms are contained in the handbook “Manual of Methods for General Bacteriology” of the American Society for Bacteriology (Washington D.C., USA, 1981).

These media that can be used according to the invention generally comprise one or more carbon sources, nitrogen sources, inorganic salts, vitamins and/or trace elements.

Preferred carbon sources are sugars, such as mono-, di- or polysaccharides. Very good carbon sources are, for example, glucose, fructose, mannose, galactose, ribose, sorbose, ribulose, lactose, maltose, sucrose, raffinose, starch or cellulose. It is also possible to add sugars to the media via complex compounds such as molasses, or other by-products of sugar refining. It may also be advantageous to add mixtures of different carbon sources. Other possible carbon sources are oils and fats, such as, for example, soya oil, sunflower oil, peanut oil and coconut fat, fatty acids, such as, for example, palmitic acid, stearic acid or linoleic acid, alcohols, such as, for example, glycerol, methanol or ethanol, and organic acids, such as, for example, acetic acid or lactic acid.

Nitrogen sources are usually organic or inorganic nitrogen compounds or materials which comprise these compounds. Examples of nitrogen sources comprise ammonia gas or ammonia salts, such as ammonium sulfate, ammonium chloride, ammonium phosphate, ammonium carbonate or ammonium nitrate, nitrates, urea, amino acids or complex nitrogen sources, such as corn steep liquor, soya meal, soya protein, yeast extract, meat extract and others. The nitrogen sources can be used individually or as a mixture.

Inorganic salt compounds which may be present in the media comprise the chloride, phosphorus or sulfate salts of calcium, magnesium, sodium, cobalt, molybdenum, potassium, manganese, zinc, copper and iron.

Sulfur sources which may be used are inorganic sulfur-containing compounds, such as, for example, sulfates, sulfites, dithionites, tetrathionates, thiosulfates, sulfides, but also organic sulfur compounds, such as mercaptans and thiols.

Phosphorus sources which can be used are phosphoric acid, potassium dihydrogenphosphate or dipotassium hydrogenphosphate or the corresponding sodium-containing salts.

Chelating agents can be added to the medium in order to keep the metal ions in solution. Particularly suitable chelating agents comprise dihydroxyphenols, such as catechol or protocatechuate, or organic acids, such as citric acid.

The fermentation media used usually also comprise other growth factors, such as vitamins or growth promoters, which include, for example, biotin, riboflavin, thiamine, folic acid, nicotinic acid, panthothenate and pyridoxine. Growth factors and salts frequently originate from complex media components, such as yeast extract, molasses, corn steep liquor and the like. Moreover, suitable precursors may be added to the culture medium. The precise composition of the media compounds heavily depends on the particular experiment and is decided upon individually for each specific case. Information on the optimization of media can be found in the textbook “Applied Microbiol. Physiology, A Practical Approach” (editors P. M. Rhodes, P. F. Stanbury, IRL Press (1997) pp. 53-73, ISBN 0 19 963577 3). Growth media can also be acquired from commercial suppliers, such as Standard 1 (Merck) or BHI (Brain heart infusion, DIFCO) and the like.

All media components are sterilized either by heat (20 min at 1.5 bar and 121° C.) or by sterile filtration. The components can be sterilized either together or, if necessary, separately. All media components may be present at the start of the cultivation or be optionally added continuously or batchwise.

The temperature of the culture is normally between 15° C. and 45° C., preferably 25° C. to 40° C. and can be kept constant or altered during the experiment. The pH of the medium should be in the range from 5 to 8.5, preferably around 7.0. The pH for the cultivation can be controlled during the cultivation by adding basic compounds such as sodium hydroxide, potassium hydroxide, ammonia or ammoniacal water or acidic compounds such as phosphoric acid or sulfuric acid. To control the development of foam, antifoams, such as e.g. fatty acid polyglycol esters, can be used. To maintain the stability of plasmids, suitable selectively acting substances, such as, for example, antibiotics, can be added to the medium. In order to maintain aerobic conditions, oxygen or oxygen-containing gas mixtures, such as e.g. ambient air, are introduced into the culture. The temperature of the culture is normally 20° C. to 45° C. The culture is continued until a maximum of the desired product has formed. This target is normally reached within 10 hours to 160 hours.

Depending on the production strain, gassing with air, oxygen, carbon dioxide, hydrogen, nitrogen or corresponding gas mixtures may be required in order to achieve good yields.

When the fermentation is complete, the fermentation broth which comprises the alkanol can be either passed directly to the further processing according to the invention. Preferably, however, biomass is firstly separated off, for example by centrifugation or filtration, and, if appropriate, washed, and the washing liquid is combined with the alkanol phase.

Prior to the further processing of the fermentation broth in the process according to the invention, the fermentation broth can be pretreated; for example, the biomass can be separated off from the broth. Processes for separating off the biomass are known to the person skilled in the art, such as, for example, filtration, sedimentation and flotation. Consequently, the biomass can be separated off for example using centrifuges, separators, decanters, filters or in flotation apparatuses. For the most complete isolation possible of the product of value, a washing of the biomass is often recommended, e.g. in the form of a diafiltration. The choice of method is dependent on the biomass fraction in the fermenter broth and the properties of the biomass, and also the interaction of the biomass with the product of value. In one embodiment, the fermentation broth can be sterilized or pasteurized.

b) Enzymatic preparation of alkanols

In preferred embodiments, the preparation of the alkanol takes place by reduction of an alkanone in the presence of an alcohol dehydrogenase.

In one particularly preferred embodiment, a biotransformation broth comprising 2-butanol is obtained by reduction of butan-2-one in the presence of an alcohol dehydrogenase (ADH) (EC 1.1.1.1).

Dehydrogenases convert ketones or aldehydes into the corresponding secondary or primary alcohols; in principle, the reaction is reversible. They catalyze the enantioselective hydride transfer to the prochiral C atom of the carbonyl compound.

The hydride ions here originate from cofactors, such as e.g. NADPH or NADH (reduced nicotinamide adenine dinucleotide phosphate or reduced nicotinamide adenine dinucleotide). Since these are very expensive compounds, they are added to the reaction only in catalytic amounts. The reduced cofactors are generally regenerated during the reaction by a second redox reaction which takes place simultaneously.

The ADH is selected, for example, from dehydrogenases from microorganisms of the genus Clostridium, Streptomyces or Escherichia. The ADH can be used in purified or partly purified form or else in the form of the microorganism itself. Processes for obtaining and purifying dehydrogenases from microorganisms are known to the person skilled in the art, e.g. from K. Nakamura & T. Matsuda, “Reduction of Ketones” in K. Drauz and H. Waldmann, Enzyme Catalysis in Organic Synthesis 2002, Vol. IM, 991-1032, Wiley-VCH, Weinheim. Recombinant methods for producing dehydrogenases are likewise known, for example from W. Hummel, K. Abokitse, K. Drauz, C. Rollmann and H. Gröger, Adv. Synth. Catal. 2003, 345, No. 1+2, pp. 153-159.

Preferably, the reduction with the ADH takes place in the presence of a suitable cofactor. Cofactors used for the reduction of the ketone are usually NADH and/or NADPH. In addition, ADH can be used as cellular systems which inherently comprise cofactors, or alternative redox mediators are added (A. Schmidt, F. Hollmann and B. Bühler “Oxidation of Alcohols” in K. Drauz and H. Waldmann, Enzyme Catalysis in Organic Synthesis 2002, Vol III, 991-1032, Wiley-VCH, Weinheim).

In particular, the reaction takes place with simultaneous or staggered regeneration of the cofactor consumed during the conversion. For this, the regeneration can take place enzymatically, electrochemically or electroenzymatically in a manner known per se (Biotechnology Progress, 2005, 21, 1192; Biocatalysis and Biotransformation, 2004, 22, 89; Angew. Chem Int. Ed Engl., 2001, 40, 169; Biotechnol Bioeng, 2006, 96, 18; Biotechnol Adv., 2007, 25, 369; Angew. Chem Int. Ed Engl., 2008, 47, 2275; Current

Opinion in Biotechnology, 2003, 14, 421; Current Opinion in Biotechnology, 2003, 14, 583).

Preferably, the reduction with the ADH takes place in the presence of a suitable reducing agent which regenerates the cofactor oxidized in the course of the reduction. Examples of suitable reducing agents are sugars, in particular hexoses, such as glucose, mannose, fructose, and also formate, phosphite or molecular hydrogen. Depending on the thermodynamic and kinetic conditions of the overall reaction, oxidizable alcohols, in particular ethanol, propanol or cost-effective secondary alcohols such as, for example, isopropanol (so-called “sacrificial alcohols”), can arise as ultimate hydride donor of the reaction.

For the oxidation of the reducing agent and, associated therewith, for the regeneration of the cofactor, it is possible to add a regenerating enzyme, such as a second dehydrogenase, such as e.g. glucose dehydrogenase (GDH) (EC 1.1.1.47) when using glucose as reducing agent, formate dehydrogenase (EC 1.2.1.2 or EC 1.2.1.43) when using formate as reducing agent or phosphite dehydrogenase (EC 1.20.1.1) when using phosphite as reducing agent. When using a sacrificial alcohol, ketone reduction and sacrificial alcohol oxidation can often be carried out by the same biocatalyst. The regenerating enzyme can be used as free or immobilized enzyme or in the form of free or immobilized cells. Its preparation can take place either separately or else by coexpression in a (recombinant) dehydrogenase strain.

The aqueous reaction media are preferably buffered solutions which generally have a pH of from 5 to 8, preferably from 6 to 8. Besides water, moreover, the aqueous solvent can comprise at least one organic compound partially miscible with water, such as e.g. isopropanol, n-butanol.

Suitable buffers are, for example, ammonium, alkali metal or alkaline earth metal phosphate buffers or carbonate buffers, or TRIS/HCl buffers, which are used in concentration of about 10 mM to 0.2 M.

The enzymatic reduction generally takes place at a reaction temperature below the deactivation temperature of the dehydrogenase used and above −10° C. It is particularly preferably in the range from 0 to 100° C., in particular from 15 to 60° C. and especially from 20 to 40° C., e.g. about 30° C.

The biotransformation can be carried out in stirred reactors, bubble columns and loop reactors. A detailed overview of the possible configurations including types of stirrer and geometric designs can be found in “Chmiel: Bioprozesstechnik: Einführung in die Bioverfahrenstechnik [Bioprocess technology: Introduction to bioprocess technology], Volume 1”. For carrying out the process, typically the following variants known to the person skilled in the art or explained e.g. in “Chmiel, Hammes and Bailey: Biochemical Engineering” are available, such as batch, fed-batch, repeated fed-batch or else also continuous fermentation with and without recycle of the biomass. Depending on the production strain, gassing with air, oxygen, carbon dioxide, hydrogen, nitrogen or corresponding gas mixtures can/must take place in order to achieve good yields.

Carrying out the enzymatic reaction can likewise take place, as described above for the fermentation, in a manner known from the literature, continuously or discontinuously. The optimal concentrations for substrate, enzymes, reduction equivalents and “sacrificial compound” can be determined directly by the person skilled in the art.

Thus, for example, WO 2006/53713 describes a process for the preparation of (S)-butan-2-ol by reducing butan-2-one in the presence of an alcohol dehydrogenase (ADH) with a certain polypeptide sequence. Preferably, the enantioselective reduction with the ADH takes place in the presence of a reducing agent, such as glucose or formate, which regenerates the cofactor oxidized in the course of the reduction. For the regeneration of the coenzyme, a second dehydrogenase, such as e.g. glucose dehydrogenase or formate dehydrogenase, can be added.

The butan-2-one is preferably used in a concentration of from 0.1 g/l to 500 g/l, particularly preferably from 1 g/l to 50 g/l, in the enzymatic reduction and can be topped up continuously or discontinuously.

For the procedure, it is possible, for example, to introduce as initial charge the butan-2-one with the ADH, the solvent and optionally the cofactors, if applicable a second dehydrogenase for regenerating the cofactor and/or further reducing agents, and to thoroughly mix the mixture, e.g. by stirring or shaking. However, it is also possible to immobilize the dehydrogenase(s) in a reactor, for example in a column, and to pass a mixture comprising the butan-2-one and optionally cofactors and/or cosubstrates through the reactor. For this, the mixture can be circulated through the reactor until the desired conversion has been reached. In the process, the keto group of the butan-2-one is reduced to give an OH group, producing essentially the (S) enantiomer of the alcohol. As a rule, the reduction will be carried out up to a conversion of at least 70%, particularly preferably of at least 85% and in particular of at least 95%, based on the butan-2-one present in the mixture. The progress of the reaction, i.e. the sequential reduction of the ketone, can be monitored here by customary methods such as gas chromatography or high-pressure liquid chromatography.

WO 2005/108590 discloses a process for the preparation of optically active alkanols where, in an alkanone-comprising medium, an enzyme (E) selected from the classes of the dehydrogenases, aldehyde reductases and carbonyl reductases is incubated in the presence of reduction equivalents, where the reduction equivalents consumed in the course of the reaction are regenerated again by reacting a sacrificial alcohol to give the corresponding sacrificial ketone with the help of the enzyme (E). The preparation of a biotransformation broth comprising S-2-pentanol is possible by the process described in WO 2005/108590.

c) Immobilization of Enzymes or Microorganisms

The enzymes used for the alkanol preparation can be used in the processes described herein in free form or in immobilized form.

An immobilized enzyme is understood as meaning an enzyme which is fixed to an inert support. Suitable support materials and the enzymes immobilized thereon are known from EP-A-1149849, EP-A-1 069 183 and DE-OS 100193773, and also from the literature references cited therein. Reference is made to the disclosure of these documents in this regard in their entirety. Suitable support materials include, for example, clays, clay minerals, such as kaolinite, diatomaceous earth, perlite, silicon dioxide, aluminum oxide, sodium carbonate, calcium carbonate, cellulose powder, anion exchanger materials, synthetic polymers, such as polystyrene, acrylic resins, phenol formaldehyde resins, polyurethanes and polyolefins, such as polyethylene and polypropylene. The support materials are used for producing the supported enzymes usually in a finely divided, particulate form, with preference being given to porous forms. The particle size of the support material is usually not more than 5 mm, in particular not more than 2 mm (sieve line).

Analogously, when using the dehydrogenase as whole-cell catalyst, it is possible to select a free or immobilized form. Support materials are e.g. Ca alginate, and carrageenan. Enzymes, like cells, can also be crosslinked directly with glutaraldehyde (crosslinking to CLEAs). Corresponding and further immobilization methods are described, for example, in J. Lalonde and A. Margolin “Immobilization of Enzymes” in K. Drauz and H. Waldmann, Enzyme Catalysis in Organic Synthesis 2002, Vol. III, 991-1032, Wiley-VCH, Weinheim. Further information on biotransformations and bioreactors for carrying out processes according to the invention can be found, for example, also in Rehm et al. (editor) Biotechnology, 2nd Edition, Vol. 3, Chapter 17, VCH, Weinheim.

The invention is illustrated in more detail by the following examples.

### Example 1

Enzymatic Reduction

An enzymatic reduction of 2-butanone to S-2-butanol was carried out in a 16 m³ reactor. For this, 7000 l of water, 43.5 kg of dipotassium hydrogenorthophosphate, 34 kg of potassium dihydrogenorthophosphate and 2.4 kg of magnesium chloride hexahydrate were introduced. After switching on the stirrer, a further 1000 l of water were introduced and the reactor was heated to 25° C. After one hour, the pH was controlled. The pH should be 6.3-6.7, and so, where appropriate, depending on the pH, 75% strength phosphoric acid or 48% strength potassium hydroxide solution were then metered in.

After adjusting the pH, 901 kg of glucose, 1.3 kg of cofactor NAD dissolved in water, 500 l of ADH biocatalyst, 400 l of glucose dehydrogenase preparation and 361 kg of 2-butanone were added.

When the addition was complete, the reactor contents were stirred for a further 24 h at an internal temperature of 25° C. During this, the pH was kept at pH 6.3-6.7 by adding 20% strength NaOH. If the conversion after 24 h was 90% or more, the reaction was terminated; in the case of the conversion being less than 90%, the reaction solution was then stirred for a further 2 h at 25° C.

### Azeotropic Distillation

The reaction discharge from the enzymatic reduction was heated to an internal temperature of about 100° C. in the 16 m³ stirred reactor at atmospheric pressure. In a single-stage distillation, about 400 kg of upper phase containing product of value were separated off via a phase separator while the aqueous phase was returned to the stirred reactor. The termination criterion for this step was the end of the two-phase nature of the distillate. After achieving this criterion, about 100 kg of single-phase distillate were additionally distilled off in order to achieve complete separation of the S-2-butanol off from the reaction discharge. The yield in this step was more than 90%.

Azeotropic Drying+Hexane Distillation

Four fractions from the azeotropic distillation were combined and azeotropically dried by means of n-hexane. For this, about 2000 kg of distillate from the azeotropic distillation were introduced as initial charge in the 16 m³ stirred reactor and admixed with 1600 kg of n-hexane. The reactor contents were heated to about 60° C. under atmospheric pressure. In a single-stage distillation, about 600 kg of aqueous lower phase were removed via the phase separator. The organic upper phase was returned to the stirred reactor. Termination criterion for this step was the end of the two-phase nature of the distillate. After achieving this criterion, about 1300 kg of the remaining n-hexane were distilled off via the attached column and then the reactor contents were cooled to room temperature. The yield in this step was more than 95%.

Purification by distillation

The crude S-2-butanol from the azeotropic drying was purified by distillation over a continuous column. The column with a diameter of 50 mm consisted of eight part sections, each of which was charged with 0.5 m of structured fabric packing (Sulzer CY). The distillation was carried out at atmospheric pressure. The crude discharge was introduced in the form of a liquid at a packing height of 3 m, and the more readily boiling fractions, such as e.g. hexane, 2-butanone and residual water, were distilled off overhead. Color-imparting, higher-boiling components were separated off via the bottom. The pure fraction was drawn off via a vaporous side take-off at a packing height of 0.5 m. The S-2-butanol was present in a purity of more than 99%, the yield of the continuous purification by distillation was more than 90%.

### Example 2

Enzymatic Reduction

An enzymatic reduction of 2-butanone to S-2-butanol was carried out in a 4 l miniplant reactor. For this, 2600 ml of water, 15 g of dipotassium hydrogenorthophosphate, 11 g of potassium dihydrogenorthophosphate and 1 g of magnesium chloride hexahydrate were introduced. After switching on the stirrer, the reactor was heated to 25° C. After one hour, the pH was controlled. The pH should be 6.3-6.7; where appropriate, depending on the pH, 75% strength phosphoric acid or 48% strength potassium hydroxide solution were metered in.

After adjusting the pH, 300 g of glucose, 0.5 g of cofactor NAD dissolved in water; 170 ml of ADH biocatalyst, 130 ml of glucose dehydrogenase preparation and 120 g of 2-butanone were added.

When the addition was complete, the reactor contents were then stirred for a further 24 h at an internal temperature of 25° C. During this, the pH was kept at pH 6.3-6.7 by adding 20% strength NaOH. If the conversion after 24 h was 90% or more, the reaction was terminated; in the case of the conversion being less than 90%, the reaction solution was stirred for a further 2 h at 25° C.

Azeotropic Distillation

The reaction discharge from the enzymatic reduction was heated to an internal temperature of about 100° C. in a 4 l miniplant reactor at atmospheric pressure. In a single-stage distillation, about 140 g of upper phase containing product of value were separated off via a phase separator while the aqueous phase was returned to the reactor. Termination criterion for this step was the end of the two-phase nature of the distillate. After achieving this criterion, about 30 g of single-phase distillate were additionally distilled off in order to achieve complete separation of the S-2-butanol off from the reaction discharge. The yield in this step was more than 90%.

Hexane Extraction

In a 500 ml separating funnel, the water-containing S-2-butanol fraction from the azeotropic distillation was admixed with about 100 ml of n-hexane and extracted at room temperature. Phase separation gave about 60 ml of an aqueous lower phase and about 240 ml of an organic upper phase. The water content of the upper phase was reduced to less than 5% as a result of the hexane extraction. The yield in this step was more than 95%.

Hexane Distillation+Purification by Distillation

The organic upper phases from two hexane extractions were combined in a 1 l miniplant reactor with attached column (packing length about 30 cm, packings 3 mm mesh wire rings) and separated via a batch distillation at atmospheric pressure and with variable reflux ratio. After a low-boiler fraction consisting of hexane, 2-butanone, S-2-butanol and water, a product of value fraction with a purity of more than 99% and also a yield of more than 90% was isolated. The higher-boiling, color-imparting components remained in the bottom of the reactor.

1.-13. (canceled)

14. A process for isolating an alkanol from an aqueous biotransformation broth, in which
a) a first alkanol phase is obtained by distilling off an alkanol/water azeotrope from the aqueous biotransformation broth and, if the azeotrope is a heteroazeotrope, phase separation of the azeotrope and separating off of an aqueous phase,
b) a second alkanol phase is obtained by
(i) liquid/liquid extraction of the first alkanol phase with a solvent as extractant; or
(ii)azeotropic drying of the first alkanol phase in the presence of the solvent as entrainer, and
c) the second alkanol phase is fractionally distilled to give a pure alkanol fraction.

15. The process according to claim 14, where the alkanol is selected from optically active 2-alkanols.

16. The process according to claim 15, where the alkanol is selected from S-2-butanol, S-2-pentanol and S-2-hexanol.

17. The process according to claim 14, where the solvent is selected from aliphatic hydrocarbons.

18. The process according to claim 17, where the solvent is n-hexane.

19. The process according to claim 14 where, for the liquid/liquid extraction, the first alkanol phase is brought into close contact with the solvent and an aqueous phase is separated off, giving the second alkanol phase.

20. The process according to claim 14, where, for the azeotropic drying, the first alkanol phase is heated in a distillation vessel in the presence of the solvent and water is removed as water/solvent azeotrope, leaving behind the second alkanol phase in the distillation vessel.

21. The process according to claim 14, where, for the fractional distillation, the second alkanol phase is continuously introduced into a fractionating column at the side, the pure alkanol fraction is drawn off as side-stream, a fraction boiling lower than the alkanol fraction is drawn off overhead and a fraction boiling higher than the alkanol fraction is drawn off in the bottom.

22. The process according to claim 14, where, for the fractional distillation, the second alkanol phase is discontinuously distilled, giving, in succession, a fraction boiling lower than the alkanol fraction, the pure alkanol fraction and a fraction boiling higher than the alkanol fraction.

23. The process according to claim 21, where the fraction boiling lower than the alkanol fraction is returned at least partly as solvent to step b).

24. The process according to claim 14, where the biotransformation broth comprises living cells, resting cells or disrupted cells.

25. The process according to claim 14, where the biotransformation broth is obtained by reduction of an alkanone in the presence of an alcohol dehydrogenase.

26. The process according to claim 25, where the biotransformation broth is obtained by reduction of 2-butanone in the presence of an alcohol dehydrogenase.
